(19) United States
(12) Patent Application Publication
(10) Pub. No.: US 2002/0190942 A1
(43) Pub. Date: Dec. 19, 2002

(54) Driving method for thin film transistor liquid crystal display

(76) Inventor: Yu-tuan Lee, Taipei (TW)

Correspondence Address: MARTINE & PENILLA, LLP, 710 LAKEWAY DRIVE, SUITE 170, SUNNYVALE, CA, 94085, US

(21) Appl. No.: 09/876,197

(22) Filed: Jun. 6, 2001

(51) Int. Cl. G09G 3/36

(52) U.S. Cl. 345/96

(57) ABSTRACT

The invention relates to a driving method for thin film transistor liquid crystal display (TFT-LCD) by applying AC or DC signals on the common electrode of the storage capacitor of each of the pixel of the TFT substrate or on the opposite electrode of the liquid crystal during video-blanking periods. The applied AC or DC signals generate a pre-added voltage on the liquid crystal of each of the pixel. Since the optical performance of liquid crystal molecules depends on the root-mean-square value of the total induced voltage, the voltage for driving all of the pixels is decreased by using the pre-added voltage applied at each of the pixel. In particular, the threshold value of driving voltage is considerably decreased, thereby, a data driver IC with lower voltage is employed so as to lower the cost.

### BACKGROUND OF THE INVENTION

(a) Field of the Invention

The invention relates to a driving method for a thin film transistor liquid crystal display (TFT-LCD), and in particular, relates to a driving method that can decrease the magnitude of the driving voltage applied at the pixels by applying AC or DC signals during video-blanking periods.

(b) Description of the Related Art

The liquid crystal molecules lying on the alignment layer in the conventional TFT-LCD have the characteristic of a unidirectional alignment, and have a pre-tilt angle before the application of driving voltage. The unidirectional alignment and the pre-tilt angle are formed by a rubbing process performed on the surface of the alignment layer that is usually formed on the surface of the ITO electrode. It is the pre-tilt angle that enables the liquid crystal molecules to tilt in the same direction so as to induce the desired changes in light transmittance characteristics after the application of external driving voltage.

FIG. 5 shows the relationship between the root-mean-square value of the voltage (V_{LC (RMS)}) applied on the liquid crystal capacitor for a pixel and the transmittance of the pixel of a LCD. As shown in FIG. 5, the root-mean-square value of the voltage (V_{LC (RMS)}) on the liquid crystal capacitor, V_{DATA}, determines the pixel to have a certain level of transmittance. However, there is no significant variation of transmittance for a pixel when the root-mean-square value of the voltage lies between 0 and V_{R}. The reason is that if the root-mean-square value of the voltage is smaller than V_{R}, the orientation of the liquid crystal molecules can hardly have a significant variation. But once the root-mean-square value of the voltage is higher than V_{R}, the orientation of the liquid crystal molecules starts to have a rapid variation in accordance with the increase of the root-mean-square value of the voltage. The V_{R} of FIG. 5 can then be defined as a threshold voltage according to the foregoing description. This V_{R} depends greatly on the pre-tilt angle, and the larger the pre-tilt angle is, the smaller the V_{R} will be.

According to the above-mentioned description, the pre-tilt angle of the liquid crystal molecules of the conventional TFT-LCD is fully controlled by the surface of the alignment layer that is usually formed on the ITO electrode. It is rather difficult in manufacturing process to adjust the surface of the alignment layer to obtain a large pre-tilt angle and at the same time maintain a good uniformity. Therefore, the above mentioned threshold voltage V_{R} is usually significantly large. Meanwhile, if the voltage of the liquid crystal capacitor varies in the range between 0 and V_{R}, no significant effect is shown as far as the transmittance of a pixel is concerned. In case the threshold voltage V_{R} can be decreased, the magnitude of the external driving voltage applied at the pixels can also be decreased, thereby the cost for driver IC's can be lowered effectively.

### SUMMARY OF THE INVENTION

The invention provides a driving method for TFT-LCD by applying a voltage signal on the common electrode of the storage capacitor of each of the pixel of the TFT substrate or on the opposite electrode of the liquid crystal during the video-blanking periods. By generating a voltage on the liquid crystal of each of the pixel in advance, the magnitude of driving voltage for driving each of the pixel can be decreased. Particularly, the threshold value of driving voltage can be decreased considerably, thereby, a Data driver IC with relatively lower voltage can be employed.

For preventing the TFT leakage, the potential of the source of transistor connected to each of the pixel electrode should be kept unchanged as possible as we can. This can be achieved by applying respectively the opposite (polarity) voltage signals on the common electrode of the storage capacitor of each of the pixel on the TFT substrate and the opposite electrode of the liquid crystal during the video-blanking period. The effects of the opposite voltage signals on the pixel's electrode potential can counterbalance each other, thus the pixel's electrode potential can be kept unchanged as possible as we can.

The above-described voltage signals applied on the common electrode of the storage capacitor of each of the pixel of the TFT substrate and the opposite electrode of the liquid crystal can be either a AC or DC signals. If DC signals are applied, the time-averaged values of the DC signals need to be zero approximately through a plurality of video-blanking periods. This is to avoid the situation that the liquid crystal is subjected to DC voltage for a long period of time such that the quality of the liquid crystal of each of the pixel may be affected.

The driving method for TFT-LCD of the invention can also be applied in the TFT-LCDs using “Storage Capacitor on Gate” configuration. That is, the storage capacitor of each of the pixel is connected to a nearby scan line. A pre-applied voltage value can be induced on the liquid crystal of each of the pixel by applying voltage signals to a nearby scan line or the opposite electrode of the liquid crystal during the same video-blanking periods.

### BRIEF DESCRIPTION OF THE DRAWINGS

FIG. 1 shows a schematic drawing of the operation principle of TFT-LCD in accordance with the invention.

FIG. 2 shows a schematic drawing of the voltage driving method for TFT-LCD of the first embodiment of the invention as compared with the conventional voltage driving method.

FIG. 3 shows a schematic drawing of the operation principle for TFT-LCD of the second embodiment of the invention employing the “storage capacitor on gate” configuration.

FIG. 4 shows a schematic drawing of the voltage driving method for TFT-LCD of the second embodiment of the invention employing the “storage capacitor on gate” configuration as compared with the conventional voltage driving method.

FIG. 5 shows the relationship between the root-mean-square value of the voltage (V_{LC (RMS)}) on the liquid crystal capacitor (C_{LC}) of a pixel and the transmittance of the pixel in a TFT-LCD.

### PREFERRED EMBODIMENTS OF THE INVENTION

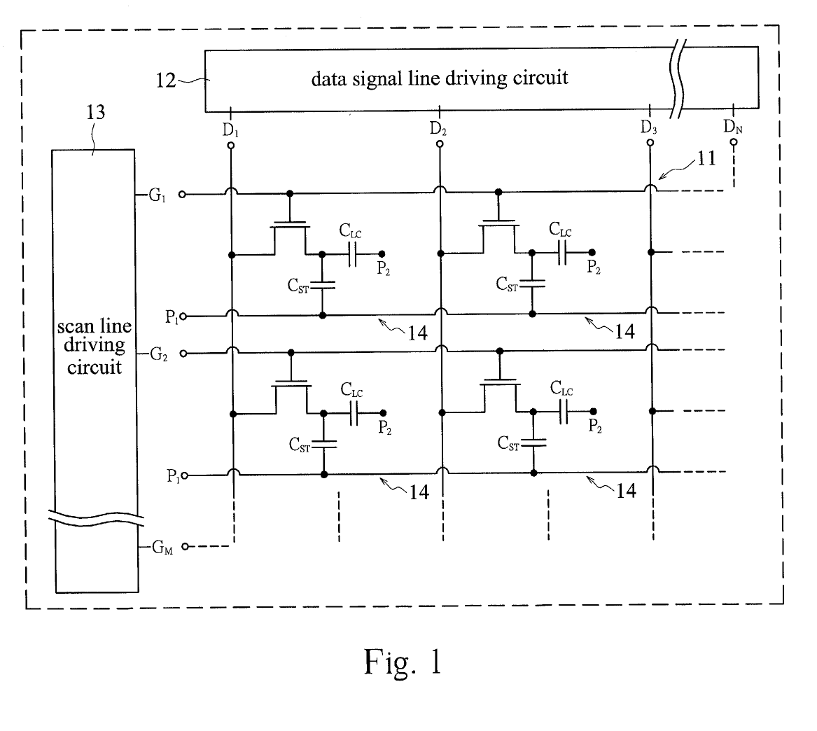

FIG. 1 shows a schematic drawing of the operation principle of TFT-LCD in accordance with the invention. As shown in FIG. 1, the schematic drawing includes a pixel array 11, a scan line driving circuit 13 and a data signal line driving circuit 12. The pixel array 11 has a plurality of pixels 14, and the driving method of each of the pixel is described as follows. G₁ is the first row of scan lines and the plurality of transistors on the scan line appears in ON-state when the scan line is under the high voltage condition. At this moment, the potential of data signal lines (D_{1.} D_{2.} D₃ . . . D_{N}) will be addressed respectively at the sources of the corresponding transistors (i.e. the pixel electrodes). This makes the liquid crystal capacitors (C_{LC}) be charged to the voltages. After the scan line (G₁) returns back to the low voltage condition, the corresponding transistors are switched to the OFF-state. Thereafter, the next scan line (G₂) turns into the high voltage condition and repeats the next step of driving process.

Among them, P₁ is the common electrode of the storage capacitor of each of the pixel on the TFT substrate while P₂ is the opposite electrode of the liquid crystal, which in general is the ITO electrode of the color filter substrate. Besides, C_{ST} is the storage capacitor and C_{LC} is the liquid crystal capacitor.

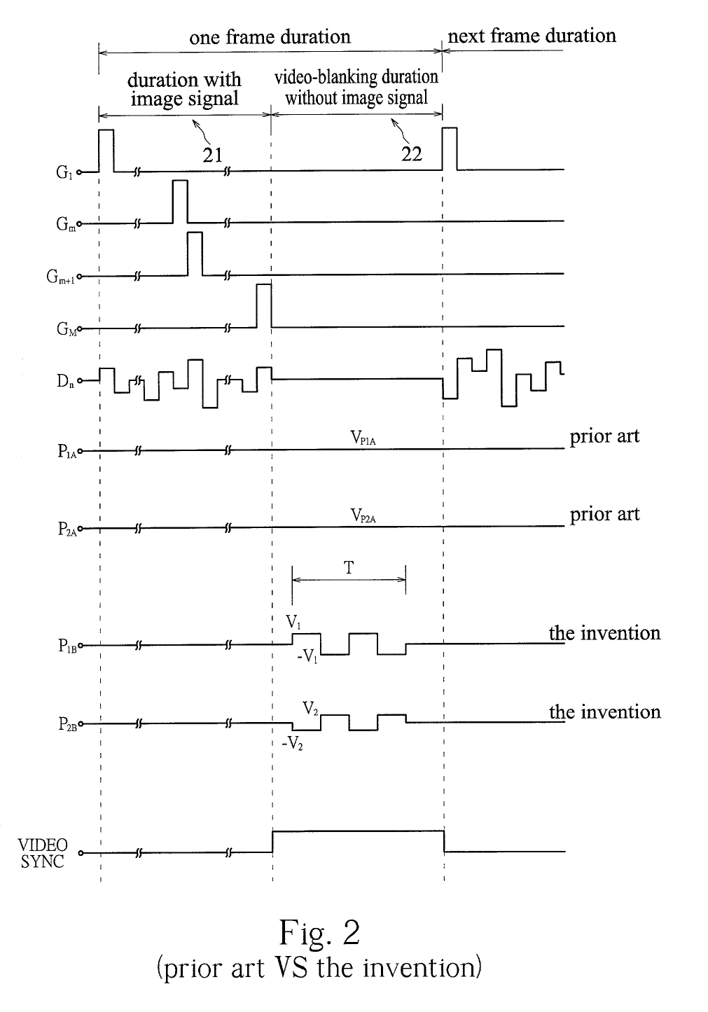

FIG. 2 is a schematic drawing of the voltage driving method for TFT-LCD of the first embodiment of the invention as compared with the conventional voltage driving method. To facilitate the explanation, the waveform of P₁ and P₂ electrodes for the voltage driving method for the prior art are denoted by P_{1A} and P_{2A} respectively while those for the invention are denoted by P_{1B} and P_{2B} respectively. As shown in FIG. 2, generally, the P_{1A} and P_{2A} of the conventional voltage driving method are connected together and are driven by DC voltage wherein V_{P1A}=V_{P2A}. On the other hand, the voltage driving method of the invention is illustrated as follows. When the TFT-LCD is in the period 21 with image data, the voltage driving method Of P_{1B} and P_{2B} of the invention coincides with the conventional configuration of P_{1A} and P_{2A}. However, when the TFT-LCD is in the video-blanking period 22 without image data, AC or DC signals are applied at P_{1B} and P_{2B}. The effect of the AC or DC signals on each of the pixel is to induce a voltage value on the liquid crystal capacitor. This voltage value is added to the voltage value addressed by the data signal lines last time on the same pixel. The potential appearing on the liquid crystal capacitor is the summation of the induced voltage and the voltage addressed by the data signal lines last time.

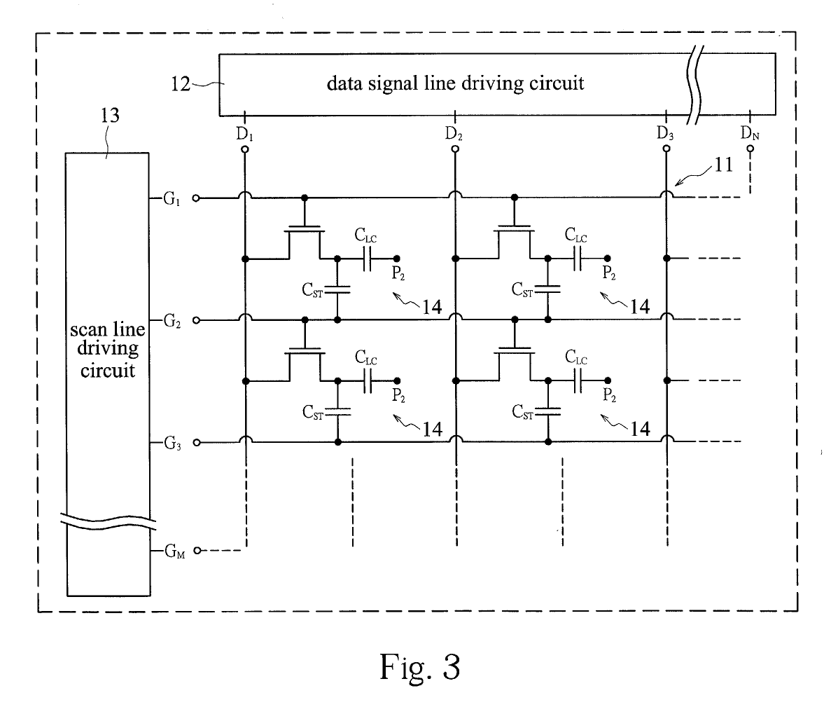

FIG. 3 shows a schematic drawing of the operation principle for TFT-LCD of the second embodiment of the invention employing the “storage capacitor on gate” configuration. As shown in FIG. 3, the main difference as compared with the first embodiment lies in the fact that the storage capacitor C_{ST} is directly connected to the next scan line. For example, the storage capacitor C_{ST} of each of the pixel positioned in the first scan line G₁ is connected to the second scan line G₂. Also, the storage capacitor C_{ST} of each of the pixel positioned in the second scan line G₂ is connected to the third scan line G₃. Similar situation can be reasoned by analogy. This configuration is called “storage capacitor on gate”. The storage capacitor of each of the pixel positioned in a certain scan line is connected to the previous scan line or the next scan line. The configuration employed in the embodiment of the invention is the one that the storage capacitor is connected to the next scan line.

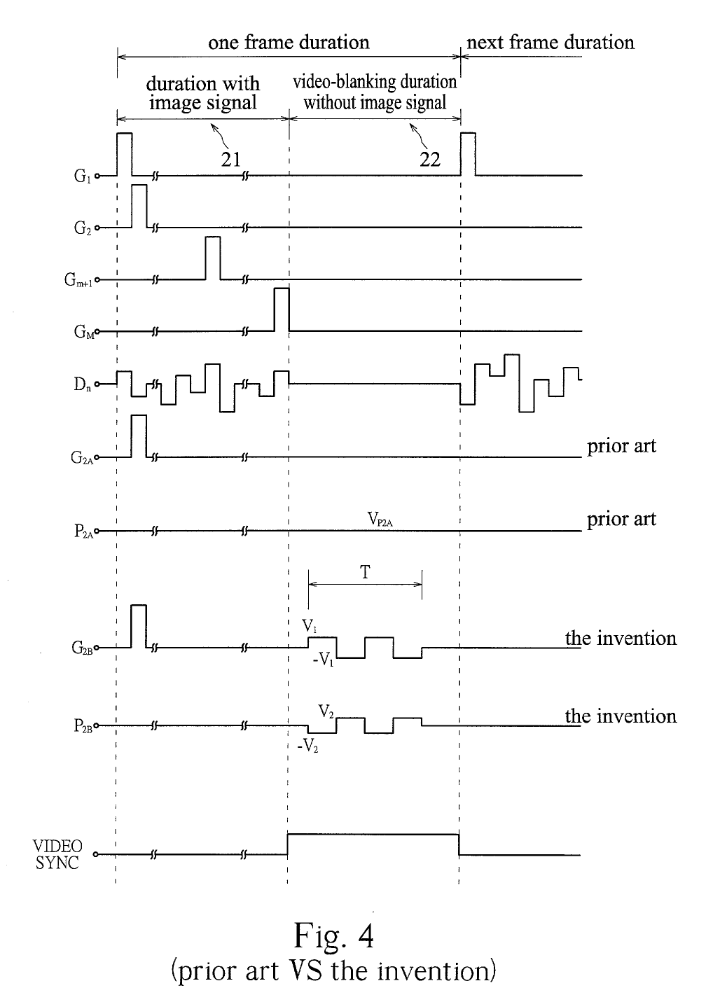

FIG. 4 is a schematic diagram of the voltage driving method for TFT-LCD of the second embodiment of the invention employing the “storage capacitor on gate” configuration as compared with the conventional voltage driving method. To facilitate the explanation, the waveforms of G₂ and P₂ electrodes for the voltage driving method for the prior art are denoted by G_{2A} and P_{2A} respectively while those for the invention are denoted by G_{2B} and P_{2B} respectively. As shown in FIG. 4, the conventional voltage driving method employs a DC voltage V_{P2A} to drive the opposite electrode P_{2A}. The common electrode for C_{ST} of each of the pixel positioned in the first scan line G₁ is connected to the next scan line G₂, thereby, the signal of the common electrode is the same as the signal of the next scan line G₂, as shown by G_{2A} of FIG. 4. On the other hand, the voltage driving method of the invention is illustrated as below. When the TFT-LCD is in the period 21 with image data, the voltage driving method of the invention coincides with the conventional configuration. However, when the TFT-LCD is in the video-blanking period 22 without image data, AC or DC signals are applied at G_{2B} and P_{2B}. The effect of the AC or DC signals on each of the pixel is to induce a voltage value on the liquid crystal capacitor. It is not necessary to go into details as they are similar to the previous ones.

In the “Storage Capacitor on Gate” configuration employed by the invention as described above, it is necessary to assure that the voltages applied in the next scan line during video-blanking periods of TFT-LCD do not induce the corresponding TFTs of the scan line into “ON” STATE.

The effective driving voltage V_{O} induced on the liquid crystal by the signals of P_{1B} and P_{2B} of FIG. 2 or the signals of G_{2B} and P_{2B} of FIG. 4 is calculated as

$${V}_{o} = ( {V}_{1} + {V}_{2} ) \times \frac{{C}_{ST}}{{C}_{ST} + {C}_{LC}} \qquad ( 1 )$$

Therefore, the pre-added root-mean-square voltage (V_{RMS}) applied at all the pixels that is caused by the signals of P_{1B} and P_{2B} of FIG. 2 or the signals of G_{2B} and P_{2B} of FIG. 4 is given as

$${V}_{RMS} = {( {V}_{o}^{2} \times \frac{T}{{T}_{FRAME}} )}^{\frac{1}{2}} = {V}_{o} \times {( \frac{T}{{T}_{FRAME}} )}^{\frac{1}{2}} \qquad ( 2 )$$

where T is the duration for applying the voltage signals during each of the video-blanking periods. T_{FRAME} is the duration of a video refresh frame.

To avoid the TFT leakage problem, the pixel electrode potential (i.e. the source potential of transistor of the pixel) should be maintained as invariable as possible. It can be achieved by considering the capacitance ratio between the liquid crystal capacitor (C_{LC}) and the storage capacitor (C_{ST}), and apply respectively the opposite (polarity) signals in the P1B and P2B waveforms or the G2B and P2B waveforms during video-blanking periods. The applied waveforms of the embodiments of FIGS. 2 and 4 are square waves for facilitating our explanation. Actually, triangle waves and/or sine waves may also be used to minimize the display non-uniformity caused by the difference of RC delay of the applied signals for pixels at different locations. The difference of RC delay for different locations is usually more significant for square waves that have abrupt changes in voltage levels.

The signals applied in P1B and P2B or G2B and P2B can also be DC signals so long as they can satisfy the condition that the average voltage value of DC signals in the long-term periods (i.e. the average of a plurality of video-blanking periods) approximates to zero. For instance, if a positive voltage of DC signal is applied in the first frame during the video-blanking period, then a negative voltage of DC signal is applied in the next frame during the video-blanking period.

It is noticed that the driving method for TFT-LCD of the invention can also be applied to the In-Plane Switching (IPS) type of LCD for which the opposite electrode on the color filter does not exist. Similar result can also be obtained by applying the AC or DC signals on the common electrode or a nearby scan line (i.e. for “common electrode on gate” configuration). It is not necessary to go into details as they are similar to the previous ones.

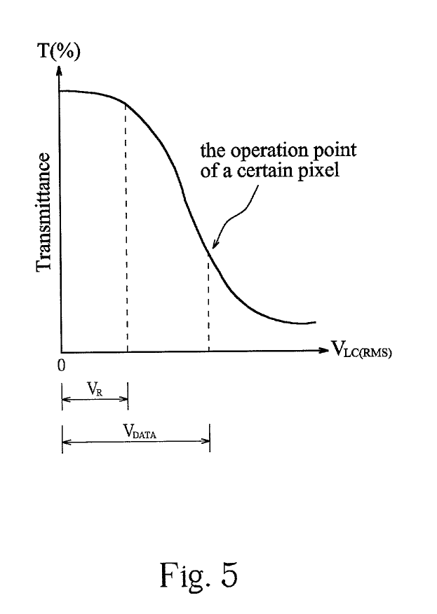

As one can see again in FIG. 5, the transmittance of a pixel depends on the root-mean-square value of the voltage (V_{LC (RMS)}) on the liquid crystal capacitor (C_{LC}). The transmittance of the liquid crystal is related to the tilt angle of the liquid crystal molecules, and the tilt angle is related to the root-mean-square voltages applied on the liquid crystal. Therefore, the transmittance of the liquid crystal is determined by the root-mean-square value of the total summation of voltages applied on the liquid crystal. It hardly has any significant variation of transmittance when the root-mean-square voltage is ranging in between 0 and V_{R}.

In the invention, the driving voltage for a data driver IC to apply at the pixel can be decreased by applying the above-mentioned voltage added in advance. Particularly, the threshold value of driving voltage (which is equivalent to V_{R} of FIG. 5) can be considerably decreased.

The invention provides a driving method for TFT-LCD that can decrease the driving voltage applied at all the pixels of TFT-LCD. Particularly, it can considerably decrease the threshold value of the driving voltage. Therefore, a data driver IC with lower voltage can be employed. Generally speaking, a Data driver IC with lower voltage is less expensive; thereby the invention can reduce the total cost of TFT-LCD.

Since the above embodiments are described only for examples, the invention is not limited to the above embodiments and various modifications or alterations can be easily made therefrom by those skilled in the art without departing from the scope of the invention.

What is claimed is:

1. A driving method for TFT-LCD making use of a video-blanking period of the TFT-LCD to apply a voltage signal on a common electrode of the storage capacitor of each of the pixel of a TFT substrate or on an opposite electrode, and then to induce a voltage on the liquid crystal for each of the pixel, thereby, the magnitude of driving voltage for each of the pixel is decreased, and in particular, the threshold value of driving voltage is considerably decreased, thereby a Data driver IC with lower voltage can be employed.

2. The driving method for TFT-LCD as claimed in claim 1, wherein during the video-blanking period, the opposite (polarity) voltages are applied respectively on the common electrode of the storage capacitor of each of the pixel of the TFT substrate and the opposite electrode of the liquid crystal, thereby, the TFT leakage of each of the pixel is prevented by maintaining the source potential of the transistor of each of the pixel as invariable as possible.

3. The driving method for TFT-LCD as claimed in claim 2, wherein the voltage signals applied on the common electrode of the storage capacitor of each of the pixel of the TFT substrate and the opposite electrode of the liquid crystal are AC signals.

4. The driving method for TFT-LCD as claimed in claim 2, wherein the voltage signals applied on the common electrode of the storage capacitor of each of the pixel of the TFT substrate and the opposite electrode of the liquid crystal are DC signals, as well as the average voltage value of each of the two DC signals during a plurality of video-blanking periods is approximately zero.

5. The driving method for TFT-LCD as claimed in claim 1, wherein the storage capacitor of each of the pixel of the TFT substrate is connected to the nearby scan lines. During video-blanking periods, the opposite (polarity) voltage signals are respectively applied to the nearby scan lines and the opposite electrode of the liquid crystal. The TFT leakage of each of the pixel can be prevented by maintaining the source potential of the transistor of each of the pixel as invariable as possible.

6. The driving method for TFT-LCD as claimed in claim 5, wherein the voltage signals applied on the scan lines and the opposite electrode of the liquid crystal during video-blanking periods are AC signals.

7. The driving method for TFT-LCD as claimed in claim 5, wherein the voltage signals applied on the scan lines and the opposite electrode of the liquid crystal during video-blanking periods are DC signals, and the average voltage value of each of the two DC signals during a plurality of video-blanking periods is approximately zero.
